(19) United States
(12) Patent Application Publication
(10) Pub. No.: US 2012/0253928 A1
(43) Pub. Date: Oct. 4, 2012

(54) Methods and Apparatus for Portfolio and Demand Bucket Management Across Multiple Advertising Exchanges

(75) Inventors: Trey Jackson, Danbury, CT (US); Gregory S. Pier, New York, NY (US); Patrick P. DeAngelis, Wilton, CT (US); Karl E. Bockley, Wilton, CT (US); Travis J. Lull, New York, NY (US); Lowell P. McLinskey, Darien, CT (US); Jason E. Morawski, Milford, CT (US); George Chkheidze, Fairfield, CT (US)

(73) Assignee: X PLUS ONE SOLUTIONS, INC., Norwalk, CT (US)

(21) Appl. No.: 13/266,312

(22) PCT Filed: May 12, 2010
(86) PCT No.: PCT/US10/34554

§ 371 Date: Jun. 8, 2012

Related U.S. Application Data
(60) Provisional application No. 61/177,846, filed on May 13, 2009.

(51) Int. Cl. G06Q 30/02

(52) U.S. Cl. 705/14.49

(57) ABSTRACT

Methods and apparatus are provided for portfolio and demand bucket management across multiple advertising exchanges. Bid requests (typically corresponding to one or more online advertising impressions) are received from a plurality of advertising exchanges. The bid requests are translated into a common format and compared to a predefined target audience specification for one or more advertising campaigns. If the translated bid request satisfies the predefined target audience specification, a bid is submitted for the online advertising impression. The predefined target audience specification is entered using a user interface and can be used for the plurality of advertising exchanges. The translation of the bid requests extracts one or more fields from the bid request and translating the extracted fields into the common format. The submitted bid comprises a dynamically determined bid price. One or more reports can optionally be generated for the plurality of advertising exchanges.

### CROSS-REFERENCE TO RELATED APPLICATION

The present application claims priority to U.S. Provisional Patent Application Ser. No. 61/177,846, filed May 13, 2009, entitled “Portfolio Management and Demand Bucket,” incorporated by reference herein.

### FIELD OF THE INVENTION

The present invention relates generally to methods and systems for online advertising, and more particularly, to a cross ad-exchange platform that provides a more cost-effective approach for online advertisers.

### BACKGROUND OF THE INVENTION

In most advertising systems, an advertiser cannot target a specific message to each individual viewer based upon on specific characteristics of the view (such as demographic or behavioral attributes). In most conventional advertising scenarios, there is normally only a small overlap between the target audience the advertiser wishes to reach, and the actual audience that is reached. The pricing is normally based on a rate card or price sheet, in a cost structure that typically does not vary with the degree of overlap between the desired target audience and actual audience of the advertisements.

Online advertising uses the Internet and World Wide Web to deliver marketing messages to potential customers. For example, online advertising includes banner advertisements on many web pages and contextual advertising on the results pages of search engines. Online advertising provides an opportunity to reduce the existing limitations of advertising with improved targeting and variable (e.g., per-impression) pricing.

A number of techniques have been proposed or suggested for further improving the effectiveness of online advertising. For example, advertising exchanges are technology platforms for buying and selling online ad impressions. Ad exchanges provide improved efficiencies for both buyers (e.g., advertisers and advertising agencies) and sellers (e.g., online publishers, such as web sites) of advertising. Advertising exchanges are evolving to permit real-time bidding by one or more advertisers for each ad impression.

While advertising exchanges have improved the efficiencies of online advertising, especially on the supply side (for example, with exchange buying companies and buying platforms), advertising exchanges still suffer from a number of limitations, which if overcome, could further improve the effectiveness of online advertising. For example, there remains a need for improved systems on the demand side of online advertising, to fulfill the goals of multiple advertisers operating across multiple ad exchanges in a real-time environment. In addition, there remains a need for methods and systems that interpret user inputs and various data points and make decisions that lead to acquiring and allocating desired online display advertising inventory across multiple stakeholders. Yet another need exists for a platform that can look across the whole real time bid (RTB) landscape and target the media that works best for the advertisers. In this manner, marketers can appropriately invest in audiences, not just in bid pricing on an exchange, but in what offer is delivered to each user.

### SUMMARY OF THE INVENTION

Generally, methods and apparatus are provided for portfolio and demand bucket management across multiple advertising exchanges. According to one aspect of the invention, bid requests (typically corresponding to one or more online advertising impressions) are received from a plurality of advertising exchanges. The bid requests are translated into a common format and compared to a predefined target audience specification for one or more advertising campaigns. If the translated bid request satisfies the predefined target audience specification, a bid is submitted for the online advertising impression.

According to another aspect of the invention, the predefined target audience specification is entered using a user interface. The predefined target audience specification can be used for the plurality of advertising exchanges. The predefined target audience specification comprises one or more of targeting criteria, budget, timing and success goals. In a further variation, the predefined target audience specification optionally comprises a selection of one or more advertising exchanges, sites and site categories. In another variation, the predefined target audience specification optionally comprises one or more of a customer data source, a third-party data source, a remarketing data source, behavioral, demographic, geographic and IP characteristics.

The translation of the hid requests extracts one or more fields from the bid request and translates the extracted fields into the common format. For example, the extracted fields comprise one or more of site, site category, auction-identifier, Internet Protocol (IP) address, user identifier and ad position.

According to yet another aspect of the invention, the submitted bid comprises a dynamically determined bid price. The bid price may be dynamically determined just prior to bid submission. The dynamically determined bid price can be based, for example, on an advertising campaign. In addition, the dynamically determined bid price can be adjusted to satisfy one or more of frequency and pacing specifications across the plurality of advertising exchanges. One or more reports can optionally be generated for a campaign to measure performance against any of the campaign setup items at various levels of detail across the plurality of advertising exchanges.

A more complete understanding of the present invention, as well as further features and advantages of the present invention, will be obtained by reference to the following detailed description and drawings.

### BRIEF DESCRIPTION OF THE DRAWINGS

FIG. 1 illustrates the matching of advertisers with publishers in accordance with the present invention to reach a target audience;

FIG. 2 illustrates an exemplary end-to-end process for matching advertisers with publishers in accordance with the present invention to reach a target audience;

FIG. 3 illustrates an exemplary advertising campaign setup hierarchy;

FIG. 4 is a flow chart describing an exemplary implementation of the advertising bidding engine incorporating features of the present invention;

FIG. 5 illustrates exemplary data formats for the real-time data store;

FIG. 6 illustrates an exemplary data format for the decision rule set;

FIG. 7 illustrates an alternate view of an exemplary end-to-end process for matching advertisers with publishers in accordance with the present invention to reach a target audience; and

FIGS. 8 and 9 illustrate exemplary reports indicating the conversions and click-through rates, respectively, of a campaign.

### DETAILED DESCRIPTION OF THE INVENTION

Generally, the present invention provides improved techniques for advertisers and/or agencies to buy online advertising to reach their target audiences in amore cost effective manner. The present invention provides methods and systems that allow the goals of multiple advertisers to be balanced operating across multiple advertising exchanges in a real-time bidding environment. Bid requests (typically corresponding to one or more online advertising impressions) are received from a plurality of advertising exchanges. The bid requests are translated into a common format and compared to a predefined target audience specification for one or more advertising campaigns. If the translated bid request satisfies the predefined target audience specification, a bid is submitted for the online advertising impression.

The present invention substantially improves the connection between users, publishers and advertisers and the effectiveness of the advertising by decreasing the “shotgun,” hard-to-measure conventional advertising approaches. According to one aspect of the present invention, advertisers are provided with a single console to interface across multiple advertising exchanges (also referred to herein as ad exchanges) in a standardized, consistent format and are provided with new levels of control across their campaign portfolio on pricing, improved targeting, and up-to-the-minute reporting results, creating a truly unique Internet advertising management platform.

Another aspect of the present invention provides a targeting and audience management platform for advertisers and agencies to use to match advertisers with publishers to reach the target audiences. The matching process includes providing listeners across ad exchanges (on which the engine listens for inventory that matches the advertiser's needs) and bidding for inventory via a real time auction when a publisher's site (represented by an exchange) is accessed by a user of interest. In this manner, advertisers can identify, target and buy specific audiences, not just inventory. The system allows advertisers to buy exchange-based media, to optimize the overall display campaign and to specify their bids and targets in advance and refine them over time, based on performance.

According to yet another aspect of the invention, the advertiser targeting strategy and correlating bid price is based on information about the user, which is evaluated by the system at the time the web site is accessed and the inventory is offered for bid by the ad-exchange. Examples of the available information includes, for example, one or more of following targeting type attributes: ad frequency caps, ad pacing rate, day, time, user time zone, country, state, city, metro, site content ratings, site format, user's browser, user's operating system, ad type, age, gender, income, channel, category, and any information from custom user lists. This process is optionally repeated for every single ad impression that is available for bidding (the impression being the smallest unit in Internet advertising).

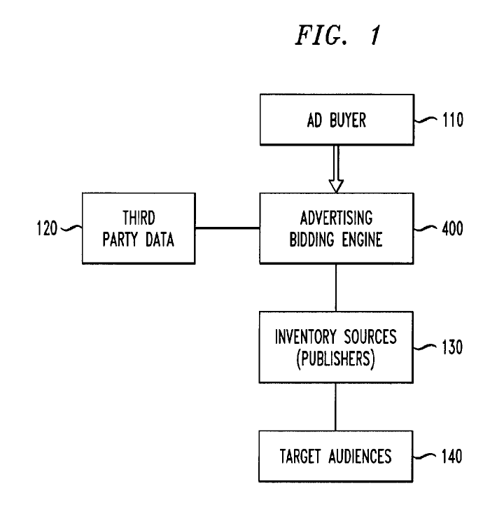

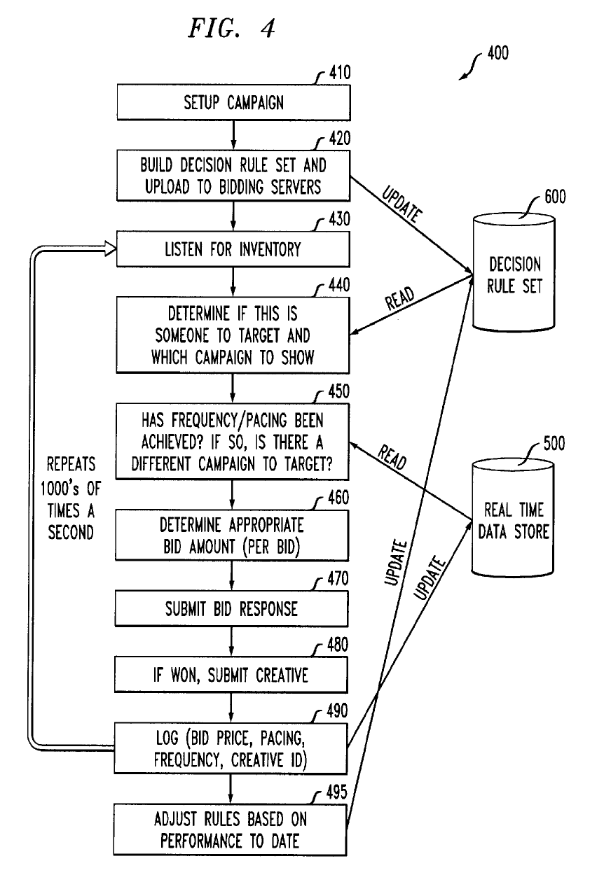

FIG. 1 illustrates the matching of advertisers with publishers in accordance with the present invention to reach a target audience. As shown in FIG. 1, one or more advertising buyers 110 can employ an advertising bidding engine 400, discussed further below in conjunction with FIG. 4, to listen in real-time to one or more advertising exchanges (not shown in FIG. 1) for available advertising inventory that matches criteria that has been predefined by the advertising buyers 110. The advertising bidding engine 400 optionally employs third party data 120, such as data from TARGUSinfo™, Experian™ or others, to optionally obtain additional targeting information about users, such as gender, age, and socio-economic data. The ad exchanges each have a corresponding exchange inventory comprised of inventory sources 130, such as web sites and other online publishers. In this manner, the advertisers can more effectively reach their target audience (end users) 140.

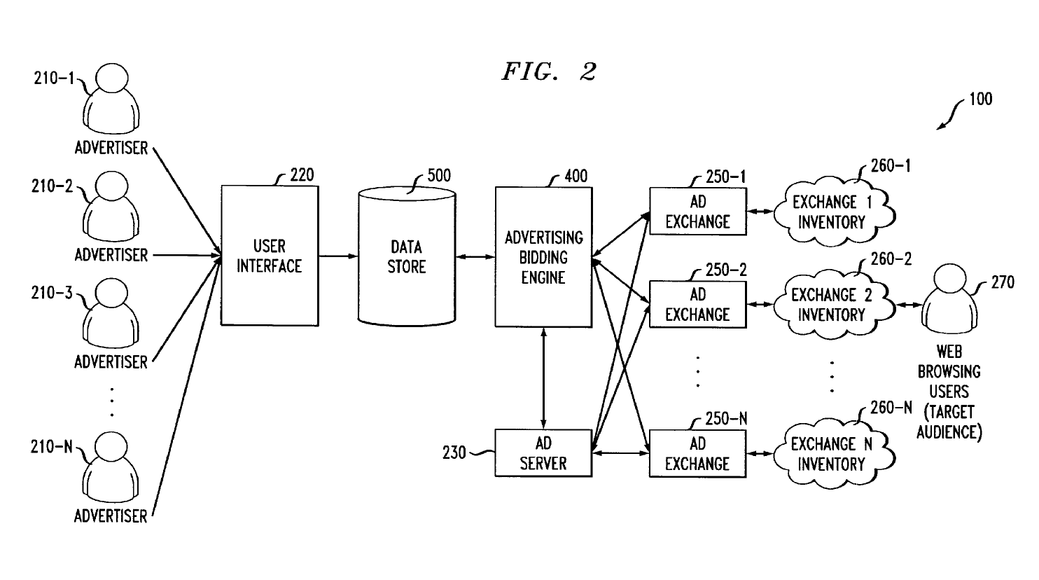

FIG. 2 illustrates an exemplary end-to-end process 200 for matching advertisers with publishers in accordance with the present invention to reach a target audience. As shown in FIG. 2, one or more advertisers 210-1 through 210-N (hereinafter, collectively referred to as advertisers 210) employ a user interface 220 to specify criteria for purchasing advertising. The advertisers 210 are buyers of online ad inventory.

The user interface 220 may optionally be implemented as one or more Application Programming Interfaces (APIs) that allow for the creation of online advertising campaigns and associated targeting criteria. The advertisers 210 can use the user interface 220 to specify, for example, the targeting criteria, budgeting, timing, and goal-setting. In addition, the user interface 220 can be used to provide reporting back to the advertisers 210 on the advertising.

The manner in which the user interface 220 is employed to set up a campaign is discussed further below in conjunction with FIG. 4, in a section entitled “Setting Up A Campaign.”

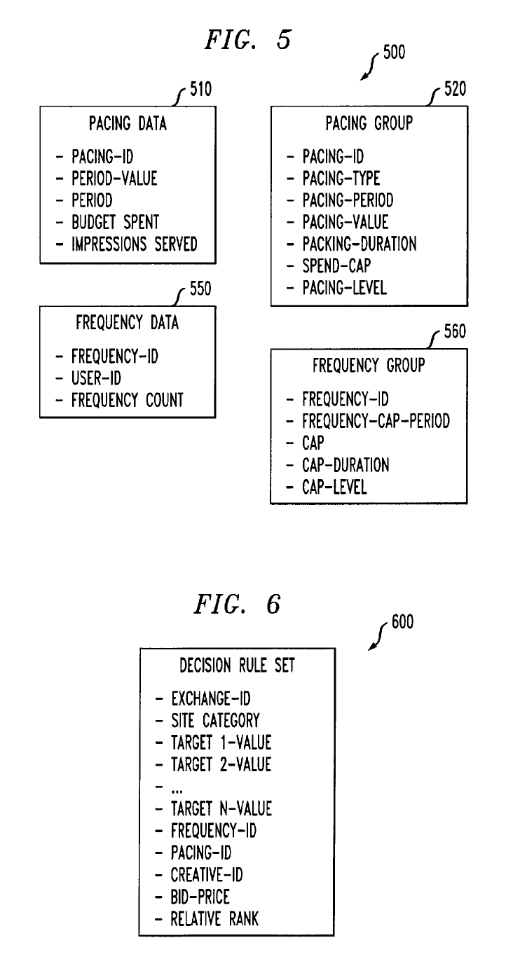

As shown in FIG. 2, the process 200 also comprises a data store 500, as discussed further below in conjunction with FIG. 5, that stores the campaign specific information as well as cross ad-exchange information. As previously indicated, the advertising bidding engine 400 performs inventory matching, logging, prioritization and bid price determination functions.

When a bid is accepted, an ad server 230 serves the specific creative that is being requested. As used herein, a “creative” is the media for an advertisement that contains the graphic design and copy. The creative is typically defined by a creative concept, offer, and, potentially, by custom characteristics.

As shown in FIG. 2, one or more ad exchanges 250-1 through 250-N (hereinafter, collectively referred to as ad exchanges 250) facilitate buyer/seller interaction by providing real-time visibility into available advertising inventory and the ability to bid on that inventory in real-time. More generally, ad exchanges 250 are technology platforms for buying and selling online ad impressions. The ad exchanges 250 each have a corresponding exchange inventory 260-1 through 260-N.

In this manner, the process 200 allows advertisers 210 to more effectively reach end users 270 (e.g., web browsing users), such as visitors to a web site, that view advertisements.

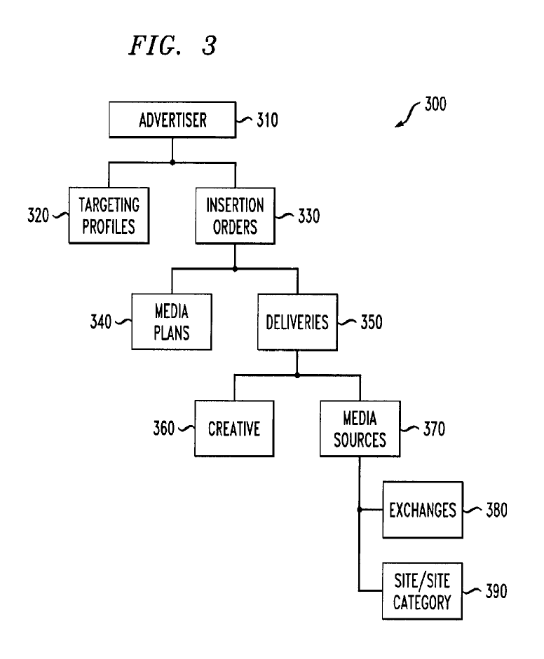

FIG. 3 illustrates an exemplary advertising campaign setup hierarchy 300. As shown in FIG. 3, an exemplary hierarchical relationship exists among advertisers, targeting profiles, insertion orders, media plans, deliveries, creative, media sources, exchanges and site (or site category).

FIG. 4 is a flow chart describing an exemplary implementation of the advertising bidding engine 400 incorporating features of the present invention.

Setting Up a Campaign

As shown in FIG. 4, the advertising bidding engine 400 initially sets up a campaign during step 410. When setting up a campaign, advertisers 210 (or their agencies) provide details for their campaign including creative(s), campaign goals, target audience definitions, frequency/pacing rules, and budgetary information. Alternatively, the targeting details and/or bid information can also be provided by a modeling process, such as the [x+1] POE modeling process. For a more detailed discussion of an exemplary modeling process, see, for example, U.S. Pat. No. 7,313,622, incorporated by reference herein. As discussed hereinafter, the user interface 220 provides a web-based interface that supports a common, exchange agnostic method for setting up the campaign.

As part of the campaign setup, advertisers 210 can specify an insertion order, which is a set of restrictions (such as targeting and frequency) from a client. The insertion order may also specify dates, a budget, and defined success using one or more goals.

The exemplary user interface 220 can be used to specify the target criteria as follows. In one exemplary implementation, the target criteria can be specified by selecting options from the following lists:

a. Optionally, select locations (country, metro area, city, . . . ) where the advertising campaigns should run;

b. Optionally, select time of day or day of week;

c. Optionally, select connection targeting information: target clients based on their internet connection speed, browser or operating system;

d. Optionally, select demographic segments;

e. Optionally, select any discrete user demographics, such as age and gender;

f. Optionally, select any detailed behavioral data, such as search terms and site context;

g. Optionally, use customer data to make decisions based on a user's shopping cart or loyalty status; and

h. Optionally, target customer lists or remarketing pools (potential customers who have exhibited some desired behavior, such as searching for a particular product and/or visiting the home page of an advertiser).

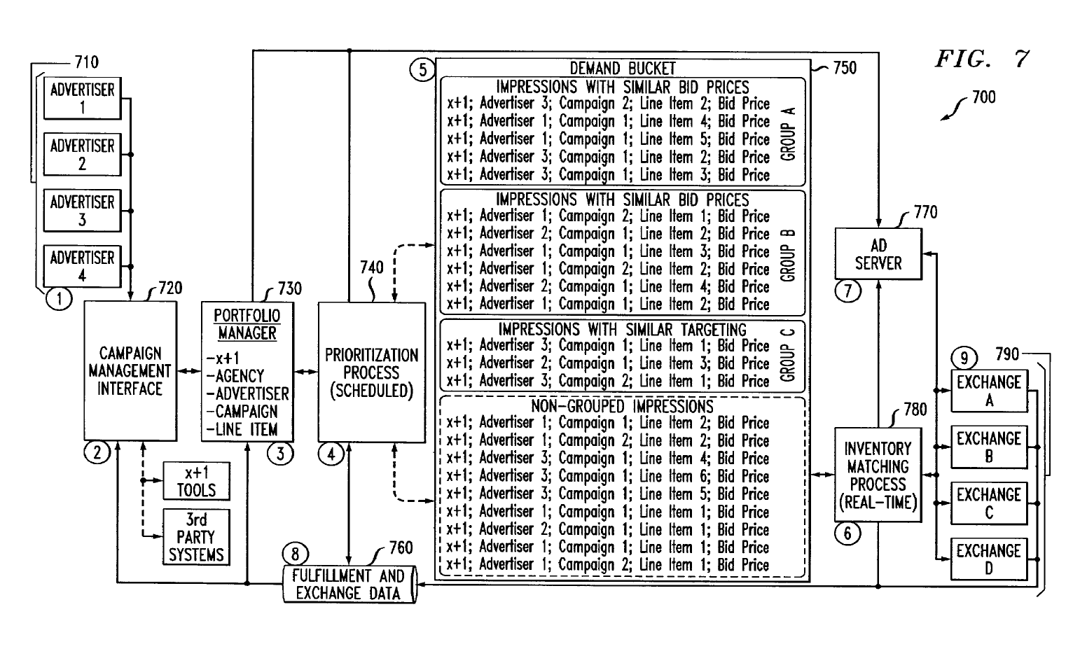

Following the campaign set-up, the advertising bidding engine 400 then transforms the campaign information to build a decision rule set 600 during step 420. The decision rule set 600 is uploaded to one or more bidding servers. An exemplary data format for the decision rule set 600 is discussed further below in conjunction with FIG. 6.

Processing Bid Requests and Submitting Bids

During step 430, the advertising bidding engine 400 listens for available inventory (e.g., bid requests from an exchange 250). The listening process comprises receiving bid requests and translating the received bid requests to a common format. Thus, during the listening process, the bid servers are waiting for incoming bid-requests which contain information about potential target users. It is anticipated that thousands of bid requests can be received every second. The bid requests must be evaluated to determine if they would be a good fit for one of the campaigns and then send a bid response back to the exchange within, for example, less than 100 hundred milliseconds (depending on exchange requirements).

When a bid request is received from an ad-exchange it is parsed during step 430 according to the syntax for that exchange. The fields of interest are extracted from the bid request and translated into a common format. The fields of interest may comprise, for example, site, site category, auction-identifier, Internet Protocol (IP) address, user identifier (e.g., a cookie-identifier), and ad position (e.g., location on page).

During step 440, the advertising bidding engine 400 determines if the bid request is associated with someone that should be targeted, and if so, which campaign to show (by matching the bid request to the decision rule set 600. In an exemplary embodiment, when a bid request is received, the bid request contains the following types of information: site, site category, position, IP address, demographic information and cookie information. The bid request information is decoded and put into a standard format for comparison to the decision rule set 600 to determine if a bid should be placed and if so, how much to bid, whether the frequency/pacing thresholds have been reached and what creative to show if the bid is won. It is noted that the matching process could alternatively be done by creating a different version of the decision rule set 600 for each exchange and comparing it that way.

During step 450, the advertising bidding engine 400 determines if the frequency/pacing of a campaign have been achieved. If so, the advertising bidding engine 400 determines if there is a different campaign to target.

If a match is found and a bid will be submitted, the advertising bidding engine 400 determines an appropriate bid amount for the bid during step 460. In this manner, the performance of a campaign can be evaluated against its goals and the bid-prices may be adjusted to win more or fewer auctions. If a campaign has exceeded its pacing, no more bids will be made until the next pacing period (hour/day/ . . . ). If a campaign is behind in reaching its goals, the pacing, frequency or bid price may be increased or vice versa.

The bid response is submitted during step 470 using an exchange specific bid format It is noted that depending on the particular exchange, the win response may not be generated until it is determined that the auction has been won. If a notification is received that the bid was successful during step 480, the system updates the real-time data store 500 (FIG. 5) with information regarding the bid, updates frequency/pacing information and submits the creative.

The bid price, pacing, frequency and creative identifier are logged during step 490

Periodically, the system can optionally make adjustments to the decision rule set 600 during step 495 based on performance, such as bid history, current status against campaign goals, or configuration changes.

Data Formats

FIG. 5 illustrates exemplary data formats for the real-time data store 500. As previously indicated, the real-time data store 500 is comprised of pacing and frequency data. The process for storing ad-views for advertisements in a centralized real-time database allows control for frequency and pacing across all publishers/ad-exchanges. The data in the real-time data store 500 is optionally used together with the decision rule set 600, for example, to balance multiple campaigns to achieve a blended set of goals. Each campaign gets a relative rank—the highest ranked item that matches the targeting criteria is the item being bid upon.

The pacing group 520 and frequency group 560 are where the pacing and frequency rules are stored. The pacing data 510 comprises a pacing-identifier, a period-value, a period, a budget spent amount, and an impressions served field. The pacing group 520 comprises a pacing-identifier, a pacing-type, a pacing-period, a pacing-value, a pacing-duration, a spend-cap and a pacing-level.

The frequency data 550 stores information on the user, such as the presented creatives, when, how often and via which exchange. The exemplary frequency data 550 comprises a frequency-identifier, a user-identifier and a frequency count. The exemplary frequency group 560 comprises a frequency-identifier, a frequency-cap-period, a cap, a cap-duration and a cap-level.

When a win notification is received from an ad exchange, the database 500 is updated with the frequency count for the frequency group id/user id combination of who received the impression and the pacing count for the pacing group id.

FIG. 6 illustrates an exemplary data format for the decision rule set 600. As shown in FIG. 6, the exemplary decision rule set 600 comprises an exchange-identifier, a site category, up to n target values, a frequency-identifier, a pacing-identifier and a creative-identifier. Each Row uniquely identifies a target audience of interest for a given campaign. For example, if people from NY and CT with dsl service are targeted to see campaign 1, the geographic (geo) target column would have the string of identifiers for NY and CT, (such as 23, 34) and the connection speed target column would have the identifier representing dsl (such as a value of 5). The other target columns would be null indicating a match for any value. The campaign identifier column would have a value of 1, the frequency and pacing columns would have the identifier associated with the frequency/pacing rule that was established.

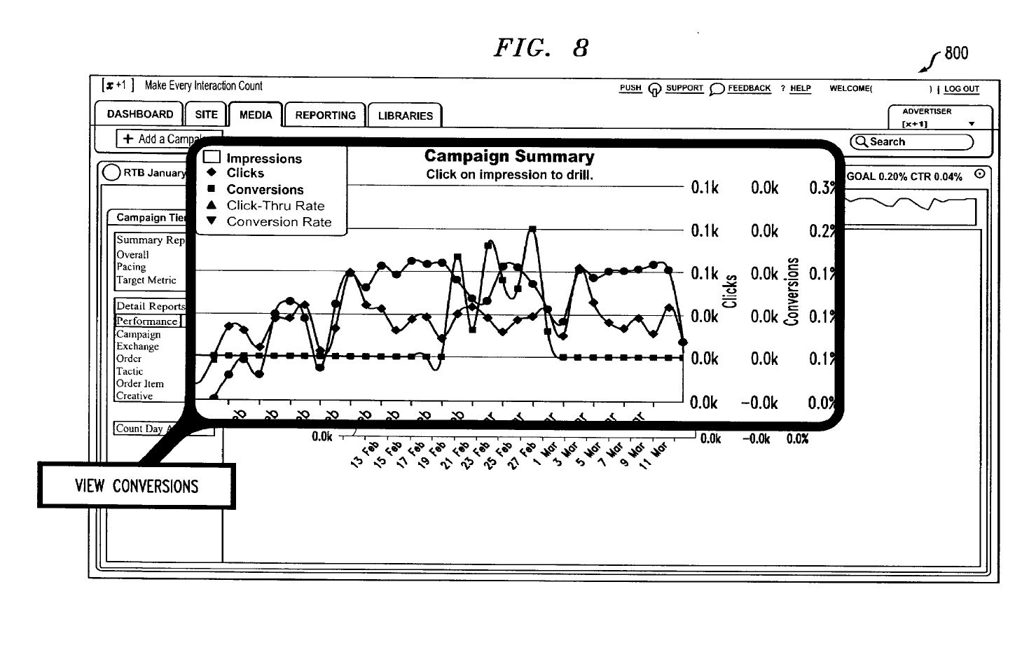

FIG. 7 illustrates an alternate view of an exemplary end-to-end process 700 for matching advertisers with publishers in accordance with the present invention to reach a target audience. As shown in FIG. 7, one or more advertisers 710-1 through 710-N (hereinafter, collectively referred to as advertisers 710) employ a campaign management interface 720 to specify criteria for purchasing advertising. The campaign management interface 720 allows for the creation of online advertising campaigns; including targeting criteria, budgeting, timing, and goal-setting, as discussed more fully above. The campaign management interface 720 allows individuals or external systems to define the parameters of an online advertising campaign for use throughout the solution. The campaign management interface 720 optionally supports a graphic user interface and connections to first-party and third-party tools.

As shown in FIG. 7, a portfolio management function 730 administers the portfolio of advertising campaigns in a hierarchical structure and balances competing objectives across members in the portfolio. For instance, an agency might manage multiple advertisers, who in turn each manage multiple advertising campaigns—each with multiple placements. The portfolio management function 730 balances the campaign management ecosystem and sets the precedence for demand fulfillment based on budgets, targeting, timing, and other factors across all stakeholders in the system to achieve a blended set of goals. A prioritization process 740 uses the information contained in the portfolio manager 730 to define an ordered list of impressions that should be bid on with the appropriate bid price. This prioritization process 740 is updated on a scheduled basis, and is affected by data from both portfolio management 730 and the impressions that have been fulfilled in the exchange.

A demand bucket 750 comprises a list of all impressions that would be bid on if they were encountered in the exchange. The impressions in this set 750 are optionally aggregated into logical groupings based on common characteristics to allow for faster decisioning.

As indicated above, the inventory matching process 780 listens in real-time to one or more advertising exchanges 790 for available inventory that matches any of the groupings or individual items in the demand bucket 750. The inventory matching process 780 also has the ability to make adjustments to bid prices based on fulfillment and bid landscape data.

An ad server 770 serves the specific creative that is being requested in the event of an auction win. If the winning bid was for a grouped demand (as per the demand bucket 750), the ad server 770 makes the final decision about which placement (advertiser and creative) to deliver.

The fulfillment and exchange data 760 comprises data that is delivered from the exchange in both batch and real-time that shows win/loss and price points for ongoing auctions, as discussed more fully above in conjunction with FIGS. 5 and 6.

Sample Reports

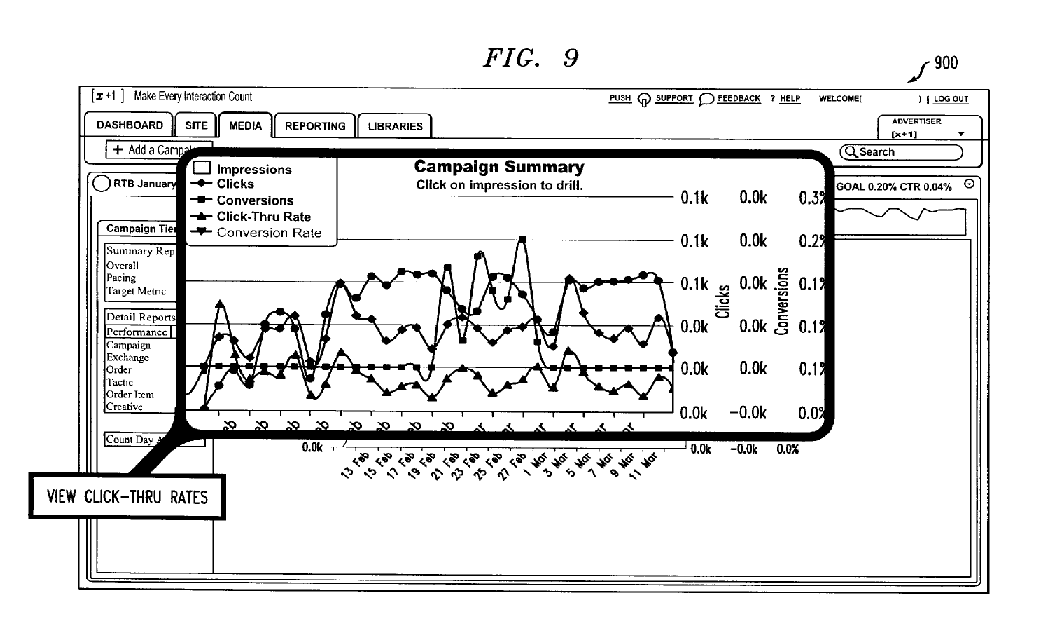

According to further aspects of the invention, real-time reports can be provided on the activity of any campaign. For example, FIGS. 8 and 9 illustrate exemplary reports 800, 900 indicating the conversions and click-through rates, respectively, of a campaign. More advanced analytics can be reported as well, to optimize the entire media campaign, from reach and frequency, overlap, or advanced attribution diagnostics, as would be apparent to a person of ordinary skill in the art. In one exemplary embodiment, the reports 800, 900 show results of the entire campaign across one or more ad-exchange(s).

Process, System and Article of Manufacture Details

While a number of flow charts herein describe an exemplary sequence of steps, it is also an embodiment of the present invention that the sequence may be varied. Various permutations of the algorithm are contemplated as alternate embodiments of the invention. While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, application specific integrated circuit, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for processing online advertising, comprising:
receiving at least one bid request from a plurality of advertising exchanges, wherein each bid request corresponds to one or more online advertising impressions;
translating said at least one bid request to a common format;
comparing said translated bid request to a predefined target audience specification for one or more advertising campaigns; and
submitting a bid for said online advertising impression if said translated bid request satisfied said predefined target audience specification.

2. The method of claim 1, wherein said predefined target audience specification is entered using a user interface.

3. The method of claim 2, wherein said predefined target audience specification comprises one or more of targeting criteria, budget, timing and success goals.

4. The method of claim 2, wherein said predefined target audience specification comprises a selection of one or more advertising exchanges, sites and site categories.

5. The method of claim 2, wherein said predefined target audience specification is used for said plurality of advertising exchanges.

6. The method of claim 2, wherein said predefined target audience specification comprises one or more of a customer data source, a third-party data source, a remarketing data source, behavioral, demographic, geographic and IP characteristics.

7. The method of claim 1, wherein said translating step further comprises the step of extracting one or more fields from said bid request and translating said extracted fields into said common format.

8. The method of claim 7, wherein said extracted fields comprise one or more of site, site category, auction-identifier, Internet Protocol (IP) address, user identifier and ad position.

9. The method of claim 1, wherein said submitted bid further comprises a dynamically determined bid price.

10. The method of claim 9, wherein said dynamically determined bid price is determined substantially close in time to said submission of said bid.

11. The method of claim 9, wherein said dynamically determined bid price is based on an advertising campaign.

12. The method of claim 9, wherein said dynamically determined bid price is adjusted to satisfy one or more of frequency and pacing specifications.

13. The method of claim 9, wherein said dynamically determined bid price is adjusted to satisfy one or more of frequency and pacing specifications across said plurality of advertising exchanges.

14. The method of claim 1, wherein said step of submitting a bid for said online advertising impression further comprises the step of balancing a plurality of campaigns to achieve a blended set of goals.

15. The method of claim 1, further comprising the step of generating one or more reports for said plurality of advertising exchanges.

16. The method of claim 1, further comprising the step of tracking in real-time one or more of win notifications, pacing, frequency and other performance data.

17. A system for processing online advertising, comprising:
a memory; and
at least one processor, coupled to the memory, operative to:
receive at least one bid request from a plurality of advertising exchanges, wherein each bid request corresponds to one or more online advertising impressions;
translate said at least one bid request to a common format;
compare said translated bid request to a predefined target audience specification for one or more advertising campaigns; and
submit a bid for said online advertising impression if said translated bid request satisfied said predefined target audience specification.

18. The system of claim 17, wherein said predefined target audience specification is entered using a user interface.

19. The system of claim 18, wherein said predefined target audience specification comprises one or more of targeting criteria, budget, timing and success goals.

20. The system of claim 18, wherein said predefined target audience specification is used for said plurality of advertising exchanges.

21. The system of claim 17, wherein said translation further comprises an extraction of one or more fields from said bid request and translating said extracted fields into said common format.

22. The system of claim 17, wherein said submitted bid further comprises a dynamically determined bid price.

23. The system of claim 22, wherein said dynamically determined bid price is adjusted to satisfy one or more of frequency and pacing specifications.

24. The system of claim 17, wherein said submitted bid for said online advertising impression balances a plurality of campaigns to achieve a blended set of goals.

25. The system of claim 17, wherein said processor is further configured to generate one or more reports for said plurality of advertising exchanges.

26. An article of manufacture for processing online advertising, comprising:
receiving at least one bid request from a plurality of advertising exchanges, wherein each bid request corresponds to one or more online advertising impressions:
translating said at least one bid request to a common format;
comparing said translated bid request to a predefined target audience specification for one or more advertising campaigns; and
submitting a bid for said online advertising impression if said translated bid request satisfied said predefined target audience specification.
